(19) United States
(12) Patent Application Publication
(10) Pub. No.: US 2026/0092797 A1
(43) Pub. Date: Apr. 2, 2026

(54) Venturi Flow Meter for Moisture-Saturated Compressed Air

(71) Applicant: CDI Meters, Inc., Woburn, MA (US)

(72) Inventor: Roger Dennison, Silver Spring, MD (US)

(73) Assignee: CDI Meters, Inc., Woburn, MA (US)

(21) Appl. No.: 19/345,996

(22) Filed: Sep. 30, 2025

Related U.S. Application Data
(60) Provisional application No. 63/700,878, filed on Sep. 30, 2024.

(51) Int. Cl. G01F 1/50; G01F 1/44

(52) U.S. Cl. CPC G01F 1/50; G01F 1/44

(57) ABSTRACT

A flowmeter of the Venturi type made suitable for use with moisture-saturated compressed air by heating passages connecting with its pressure sensors and heating the pressure sensors themselves.

### CROSS-REFERENCE TO RELATED APPLICATION

This application claims priority of Provisional application 63/700,878, filed on Sep. 30, 2024.

### FIELD

A differential-pressure based flowmeter suitable for metering the flow of compressed air that has not been through a dryer and consequently may be saturated with water vapor.

### BACKGROUND

Air commonly leaves an industrial air compressor saturated with moisture and at a temperature above that of the surrounding space. If its flow is to be sensed with a technology that depends on sensing small pressure differences, passages from the flowing region to the pressure sensors must be maintained free of occlusion by condensing moisture. In addition, most low-cost differential-pressure sensors are not suitable for long-term exposure to liquid water and contain small passages that would be easily bridged by condensation.

### SUMMARY

The subject invention relates to a flow meter of the Venturi type adapted for use with moisture-saturated compressed air. The meter senses absolute pressure and differential pressure with commercially-available pressure sensors of the type that mount on a printed circuit board. To prevent condensation within the sensors and within small passages leading to them, the invention provides for the passages to be formed in a block of thermally-conductive material and for that block and the sensors themselves to be heated to a temperature above the dewpoint of the measured air. This temperature can be relatively fixed, and at a temperature above that of the gas. Relatively fixed in some case means within normal error of a controlled temperature, such as +/−1-2 degrees F, or up to +/−5 degrees F from fixed. The invention in one example further provides for the required heat to be provided by resistors mounted on the circuit board on which the pressure sensors are mounted, with that circuit board being thermally linked to the conductive block. It further provides for the conductive block to be thermally isolated from the body of the meter by a base of thermally-insulating material. The gas may be but need not be air.

In an aspect a differential-pressure based flowmeter for moisture-saturated gas to be measured includes one or more pressure sensors and one or more passages between the measured gas and the pressure sensors. At least one passage between the measured gas and at least one pressure sensor is heated, to inhibit condensation of moisture.

In some examples the one or more passages are formed in a thermally-conductive material that is heated by heat transferred from and generated by a circuit board on which the pressure sensors are mounted. In some examples control is provided to maintain the temperature of at least one of the pressure sensors above the temperature of the measured gas. In an example the control maintains the temperature of at least one of the pressure sensors at a relatively fixed temperature. In an example there are two pressure sensors.

In some examples the flowmeter also includes a thermistor configured to sense the temperature of the gas. In some examples the thermistor is located in an annular space that receives the gas before it enters a passage. In some examples the thermally-conductive material is a block of material. In some examples there are two passages in the block of material. In some examples the two passages are heated due to the block being heated.

In another aspect a differential-pressure based flowmeter for moisture-saturated gas to be measured includes at least two pressure sensors, two passages between the measured gas and the pressure sensors, wherein the passages are formed in a block of thermally-conductive material that is heated by heat transferred from and generated by a circuit board on which the pressure sensors are mounted, to thereby heat at least one passage. a sensor configured to sense the temperature of the gas, and control maintain the temperature of at least one of the pressure sensors at a relatively fixed temperature and above the temperature of the measured gas.

In an example the sensor is a thermistor is located in an annular space that receives the gas before it enters a passage. In an example the gas is air.

### BRIEF DESCRIPTION OF THE DRAWINGS

Other objects, features and examples will occur to those skilled in the art from the following description and the accompanying drawings, in which:

FIG. 1 is an overall view of the proposed flow meter.

FIG. 2 is a view of the sensing module, including the circuit board, the thermally conductive core, and the thermally isolating base.

FIG. 3 is a view of the sensing module partly from below.

FIG. 4 is a view of the thermally-conductive core.

FIG. 5 is a front view of the circuit board.

FIG. 6 is a back view of the circuit board.

FIG. 7 is a view of the nozzle and the ring, partially in section, showing the path of the thermistor lead into the pressurized space.

FIG. 8 is a view of the ring and flow nozzle mounted within a pipe and between flanges, partially in section, showing the paths through which pressures from the entrance of the meter and its throat are routed to the sensing module.

FIG. 9 is a sectional view of the isolating base, the core and the circuit board, showing how thermal connection and isolation are provided.

### DETAILED DESCRIPTION

This disclosure pertains to a design of pressure-based flowmeter intended for use with moisture-saturated air in which the pressure sensors and the small passages connecting them to the body of the meter are heated to prevent occlusion of the passages and possible damage to the sensors by condensation.

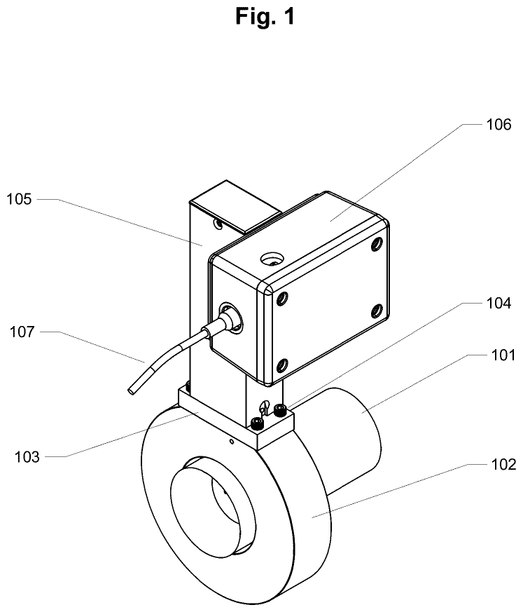

FIG. 1 shows key elements of the flowmeter. The body of the meter consists of the Venturi nozzle, 101, mounted within a ring, 102, that clamps between pipe flanges (not shown) and is sealed with gaskets (also not shown). Attached to the ring is the thermally-isolating base 103, held in place by screws 104. A housing, 105, supports the electronic enclosure 106 which performs control, calculation, display and communication functions and is powered by a cable 107.

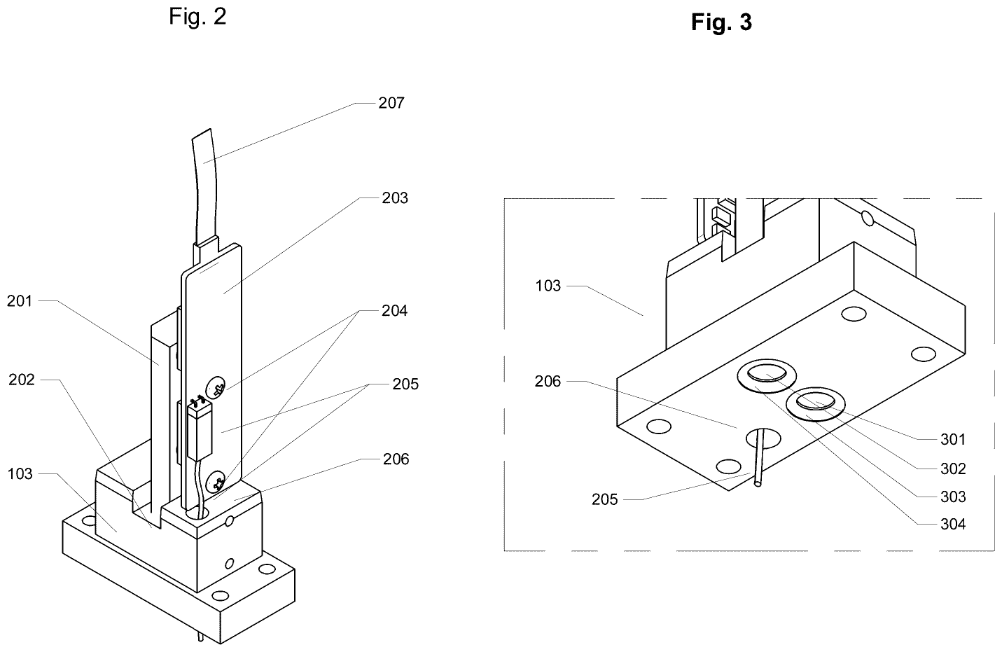

FIG. 2 shows how the differential pressure, absolute pressure and temperature sensing functions are combined into a module that can easily be integrated into the meter. The base, 103, is made of a material of low thermal conductivity, such as nylon. It supports the core, 201, and anchors it in a slot, 202, by means of set screws, not visible. Circuit board 203 is secured to the core by screws, 204, made of a metal such as brass selected for high thermal conductivity. Also visible in this view is thermistor lead 205 which connects removably to circuit board 203 and threads through a hole 206 in the thermally-conductive base. Ribbon cable 207 connects the circuit board to the circuitry in the electronic enclosure.

FIG. 3 shows the underside of base 103. The high-pressure 301 and low pressure 302 ports seal to the ring below by means of 0-rings 303 and 304. Also visible is passage 206 and, exiting it, thermistor lead 205.

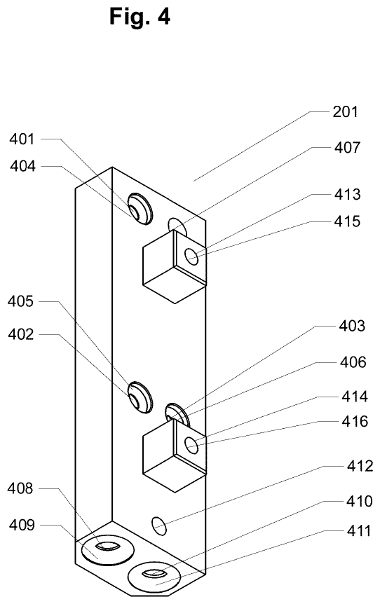

FIG. 4 shows thermally-conductive core 201. It is made of a metal of good thermal conductivity, such as Aluminum, to maintain a uniform temperature throughout its extent. It has three holes, 401, 402 and 403, with counterbores for 0-ring seals, to accept the two ports of the differential-pressure sensor and the one active port of the absolute-pressure sensor. O-rings, 404, 405 and 406 are shown in place. A fourth hole, 407, provides clearance for an unused port of the absolute-pressure sensor.

Internal high-pressure passage 408, connecting to holes 401 and 402, is visible on the underside of the core, surrounded by partially-recessed O-ring 409 to form a face seal against base 103 (not shown). Similarly, low-pressure passage 410, connecting to hole 403, is visible and is surrounded by partially-recessed O-ring 411.

Through hole 412 engages with cone-point set screws at both ends to accurately locate and secure the core within base 103.

Two bosses, 413 and 414, provide support for and thermal connection to the circuit board. Each has a threaded hole, 415 and 416, to receive a screw. The height of the bosses is such that the circuit board can press against them when its mounting screws are tightened.

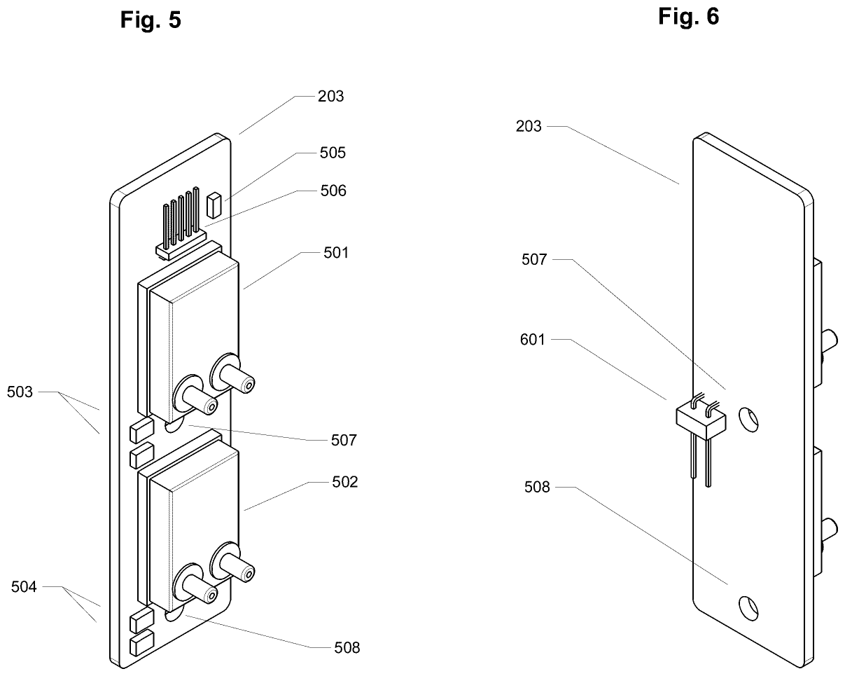

FIG. 5 shows circuit board 203. Shown in this view are absolute-pressure sensor 501, differential-pressure sensor 502, heating resistors 503 and 504, memory 505 and pin header 506 for connection by ribbon cable 207 (not shown) to electronic enclosure 106 (also not shown). The memory allows the board to be calibrated and for its calibration to travel with it.

Holes 507 and 508 are provided for screws 204 and 205 which secure the circuit board to bosses 413 and 414 of the thermally-conductive core. To facilitate heating of the core while minimizing temperature gradients across the circuit board, both sides of the circuit board are covered with copper with minimal interruptions, and the heating resistors are placed as close as possible to the areas where the bosses contact the board.

FIG. 6 shows the reverse side of the circuit board, with pin header 601 for connection to thermistor lead 205 (not shown). A network consisting of the thermistor and two precision resistors on the circuit board provides an analog temperature signal that is converted to a digital signal by an analog-to-digital convertor (not shown) on the circuit board. This signal is linearized by the microprocessor in the electronic enclosure.

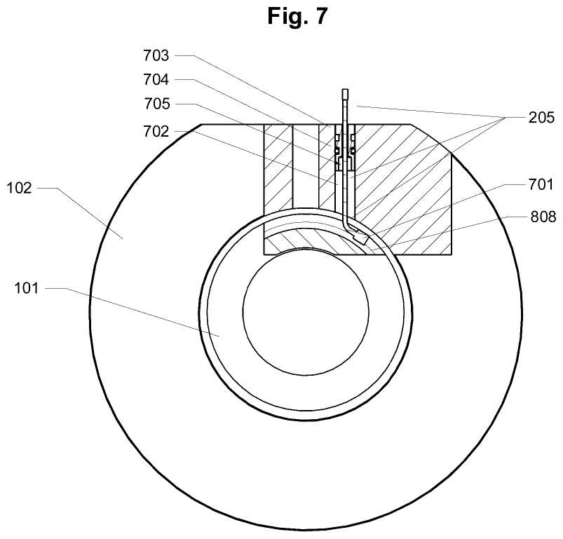

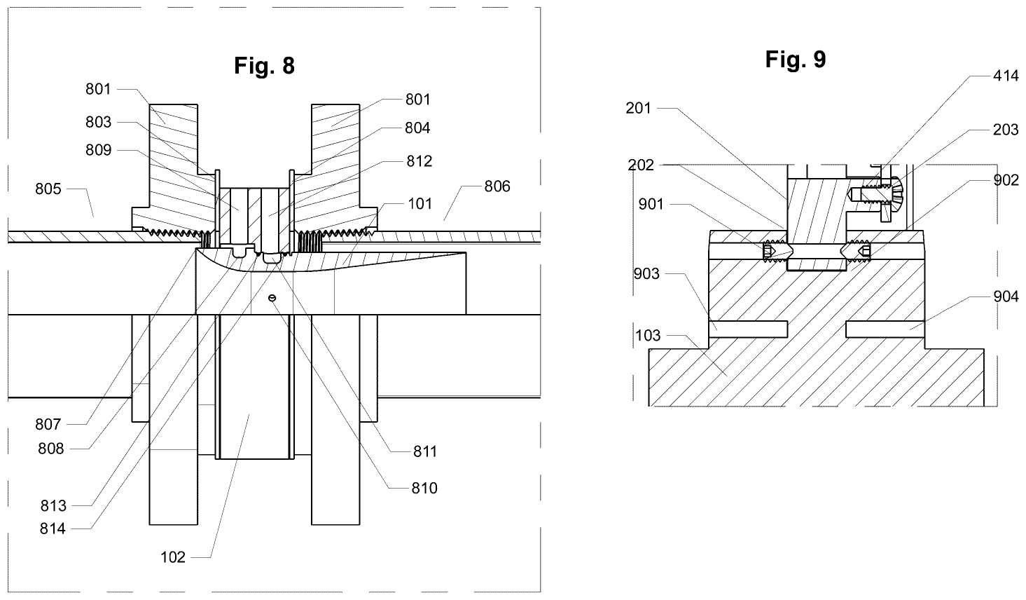

FIG. 7 is a partial section view of the ring 102 and the nozzle 101 showing the routing of the thermistor lead 205. The lead, with the thermistor 701 at its end, is threaded through hole 702 in the ring. Seal 703, consisting of a turned part and an o-ring 704, is inserted into the hole and secured in place by set screw (not visible). Where the lead passes through the seal it is potted with epoxy or some other suitable sealant 705. The thermistor at the end of the lead is in annular space 808 which communicates with the gap through which the pressure at the entrance of the meter is sensed. This annular space is better seen in FIG. 8.

FIG. 8 is a partial section through the body of the meter and the flanges and pipes between which it is mounted. The ring section of the meter, 102, is clamped between flanges 801 and 802 and sealed with gaskets 803 and 804. The flanges are held together with bolts, not shown. Air enters through pipe 805 and leaves through pipe 806. As the air accelerates approaching the throat of the nozzle its pressure drops, and most of this loss of pressure is recovered as it leaves the nozzle. The meter senses the higher pressure of the lower-velocity air entering the nozzle at gap 807 between the entrance of the nozzle 101 and the wall of pipe 805. This gap communicates with annular space 808 and thence with high-pressure passage 809, which in turn communicates with the high-pressure passage in isolating base 103 (not shown). The reduced pressure at the throat of the nozzle is sensed through four holes, one of which, 810, is visible. They communicate with annular space 811 and thence with low-pressure passage 812 which communicates with the low-pressure passage in the isolating base. O-rings, 813 and 814, prevent air from leaking into the low-pressure space from higher-pressure spaces on either side.

FIG. 9 is a partial section through the thermally-isolating base 103, the thermally-conductive core 201 and the circuit board 203 showing how the core is physically supported while being thermally isolated, and how close thermal contact is achieved between the circuit board and the core. The core is fitted into a close-fitting slot 202 in the base, and it is held in position by two short cone-pointed set screws 901 and 902. The screws are short to minimize the diffusion of heat into the base and they are pointed to pull the core into alignment during assembly. Thermal isolation is enhanced by the core having a low-emissivity surface, such as polished Aluminum, and being enclosed in housing 109 (not shown) to isolate it from air movement.

The thermal connection between the circuit board and the core is also illustrated in the figure. Thermally-conductive screw 203 provides a thermal path from the copper on the outer surface of the circuit board to boss 414 while pressing the board against the boss, creating a thermal path from the copper on the inner surface of the circuit board to the boss.

Holes 903 and 904 are mounting holes for affixing the housing. The passages for air pressure and for the thermistor cable are out of plane and consequently not shown.

Methods of calculating gas flow using a differential producer, such as a nozzle or a Pitot tube, and measured differential pressure, absolute pressure and temperature are well known and will not be discussed here. The interest here is in heating the passages necessary to conduct pressure from the body of the meter to the pressure sensors, and heating the sensors themselves, sufficiently to prevent condensation. That can be achieved by maintaining the passages above the temperature of the flowing air. Board-mounted differential-and absolute-pressure sensors, such as Superior Sensor Technology ND005D and ND150A respectively, provide sensor temperature along with pressure values. The temperature provided by either of these sensors can be used as a proxy for the core temperature as long as an allowance is made for the fact that the core will be somewhat cooler than the temperature of the sensors mounted on the circuit board. Thus, the microcontroller, using available temperature signals, controls the power to the heating resistors 503 and 504 to maintain the sensor temperature above the measured air temperature by an amount sufficient to ensure that the core temperature will always be above the air temperature. Portions of the meter that cannot be readily heated can be protected from accumulation of water by the use of a hygroscopic coating.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A differential-pressure based flowmeter for moisture-saturated gas to be measured, comprising:
one or more pressure sensors; and
one or more passages between the measured gas and the pressure sensors;
wherein at least one passage between the measured gas and at least one pressure sensor is heated, to inhibit condensation of moisture.

2. The flowmeter of claim 1 wherein the one or more passages are formed in a thermally-conductive material that is heated by heat transferred from and generated by a circuit board on which the pressure sensors are mounted.

3. The flowmeter of claim 2 wherein control is provided to maintain the temperature of at least one of the pressure sensors above the temperature of the measured gas.

4. The flowmeter of claim 3 wherein the control maintains the temperature of at least one of the pressure sensors at a relatively fixed temperature.

5. The flowmeter of claim 3 comprising two pressure sensors.

6. The flowmeter of claim 3 further comprising a thermistor configured to sense the temperature of the gas.

7. The flowmeter of claim 6 wherein the thermistor is located in an annular space that receives the gas before it enters a passage.

8. The flowmeter of claim 2 wherein the thermally-conductive material is a block of material.

9. The flowmeter of claim 8 wherein there are two passages in the block of material.

10. The flowmeter of claim 9 wherein the two passages are heated due to the block being heated.

11. The flowmeter of claim 1 wherein the gas is air.

12. A differential-pressure based flowmeter for moisture-saturated gas to be measured, comprising:
at least two pressure sensors;
two passages between the measured gas and the pressure sensors, wherein the passages are formed in a block of thermally-conductive material that is heated by heat transferred from and generated by a circuit board on which the pressure sensors are mounted, to thereby heat at least one passage;
a sensor configured to sense the temperature of the gas; and
control maintain the temperature of at least one of the pressure sensors at a relatively fixed temperature and above the temperature of the measured gas.

13. The flowmeter of claim 12 wherein the sensor is a thermistor is located in an annular space that receives the gas before it enters a passage.

14. The flowmeter of claim 13 wherein the gas is air.
